(19) United States
(12) Patent Application Publication
(10) Pub. No.: US 2006/0152708 A1
(43) Pub. Date: Jul. 13, 2006

(54) Multiparametric detection in a fluidic microsystem

(76) Inventors: Torsten Muller, Berlin (DE); Stefan Hummel, Haseldorf (DE); Annette Pfennig, Berlin (DE); Gabriele Gradl, Berlin (DE); Axel Bonsen, Hamburg (DE); Thomas Schnelle, Berlin (DE); Rudiger Meyer, Hamburg (DE)

Correspondence Address: THE LAW OFFICE OF RANDALL T. ERICKSON, P.C., 425 WEST WESLEY STREET, SUITE 1, WHEATON, IL, 60187, US

(21) Appl. No.: 10/544,423

(22) PCT Filed: Feb. 4, 2004
(86) PCT No.: PCT/EP04/01031

§ 371 Date: Dec. 13, 2005

(30) Foreign Application Priority Data
Feb. 5, 2003 (DE) 10304653.4
May 9, 2003 (DE) 10320956.5

(51) Int. Cl. G01N 21/00

(52) U.S. Cl. 356/73

(57) ABSTRACT

Disclosed is a method for measuring properties of particles that move through a fluidic microsystem, the particles being suspended in a liquid. According to the inventive method, a first parameter of a specific particle is first measured at a first test station (11). A second parameter of the particle is then measured at an interval from the first measurement at a second test station (12) which is spatially separated from the first test station (11), and the first and second parameters are jointly evaluated in a correlated manner, the first and second parameters being characteristic of different properties of the tested particle. The evaluation comprises a comparison of the first and second parameters with predetermined expected values. Another measurement is taken or manipulations are performed on the tested particle according to the result of the comparison. Also disclosed is a fluidic microsystem that is designed for implementing the inventive method.

The present invention relates to methods for measuring properties of particles which move through a fluidic microsystem suspended in a liquid, and measurement devices and fluidic microsystems which are set up to execute methods of this type.

It is generally known to characterize small objects, in particular biological cells, by optical measuring methods which are based on the detection of fluorescent light or on scattered light or transmitted light measurements (e.g., phase contrast measurements). Typically, multiparametric analyses are necessary for characterizing cells, in which, for example, morphological properties and material properties of the cells are detected.

In conventional flow cytometry, cells are hydrodynamically focused in flow cytometers, isolated into droplets, and characterized when passing a detector by recording fluorescent and scattered light signals simultaneously (parallel in time). Flow cytometers do have a high throughput because of the high droplet velocity of, for example, 10 m/s. However, the high hydrodynamic strain of the cells is a disadvantage, so that the cell vitality is strongly restricted. Further disadvantages of the flow cytometers are that sterile operation is not possible and more complicated measurements, such as kinetics measurements or morphological assays, in particular of cell components, are only possible with difficulty or are excluded.

Furthermore, assaying particles, in particular biological cells, suspended in fluidic Microsystems in the suspended state is generally known. For example, single cell analysis is provided in a hybrid chip, in which cells are manipulated using dielectric elements under the effect of negative dielectrophoresis and are subjected to high-resolution microscopic assaying methods at a measuring station (see, for example, T. Müller et al. in “Biosensors & Bioelectronics” Vol. 14, 1999, pages 247-256). In order to first focus cells in the suspension stream in a channel of the microsystem, dielectric arranging elements (so-called funnels) are used. Subsequently, the cells are held stable in a dielectric field cage for a specific detection time at a very low flow velocity (less than 50 μm/s) for a fluorescence measurement. Measuring particle properties in fluidic Microsystems does have advantages in regard to the high specificity and the high resolution capability of the measurements, the possibility of sterile operation, and the particle-specific procedure after the measurement, when depositing cells in culture vessels, for example. However, the significantly lower throughput of the fluidic Microsystems, in comparison to flow cytometry in particular, is disadvantageous.

Attempts to elevate the throughput of the fluidic Microsystems through automatic detection technologies, in which the movement state of the cells is registered using a detector mask in particular, are known (see DE 199 03 001, DE 101 20 498). However, it is also required in these technologies that the quality of the objects, i.e., for example, the suitability of biological cells for subsequent processing or cultivation steps, be evaluated visually by an operator. The operator decides, while observing an image enlarged using the microscope, which objects are selected for a high-resolution measurement or for further steps. This evaluation requires a specially trained operator, is time-consuming, tiring, and disadvantageous because of the subjectivity of the decision. For example, weakly fluorescent objects may possibly not be recognized by an operator. Differentiation aids may only be given by an additional, possibly stressful illumination of the cells.

The object of the present invention is to provide improved methods for measuring properties of particles in fluidic microsystems, using which the disadvantages of the typical measuring methods are overcome and which particularly allow increased throughput and automation of the measurement. It is also the object of the present invention to provide improved measuring devices and/or fluidic microsystems for implementing the measuring methods.

These objects are achieved by methods, measuring devices, and microsystems having the features according to Claims 1, 18, or 22. Advantageous embodiments and applications of the present invention result from the dependent claims.

A basic idea of the present invention is to refine a method for measuring properties of particles moving through a fluidic microsystem suspended in a liquid, having at least two chronologically and spatially offset measurements on a specific particle and a subsequent joint, correlated evaluation of the measurement results, in such a way that the measurement results are characteristic for different properties of the measured particle, and the evaluation comprises a comparison of both measurement results with predefined expected values, in order to cause further measurements or manipulations on the measured particle as a function of the result of the comparison. It may be especially advantageous to register a morphological (e.g., geometrical) parameter and a material parameter of the observed particle sequentially. Such a combination allows classification of the particle with increased reliability and reproducibility and reliable activation of following processes, such as a supplementary precision measurement or sorting.

By the inventive combination of at least two spatially separated measuring stations which are positioned in a shared channel through which liquid is flowing for performing the measurements, which are directed to different parameters (properties) of the particle and are analyzed in a correlated way, the disadvantages of the typical measurement in fluidic Microsystems may advantageously be overcome. The throughput may be increased because the measurements are performed more rapidly with a flowing stream. While a particle is completely measured and the parameters determined for this particle are evaluated, the next particle following in the stream through the microsystem may be subjected to the first measurement. Mutual interference of the detection procedures by undesired scattered light, for example, can be avoided by the spatial separation of the measuring stations. The freedom from interference allows a reproducible and objective measurement independently of an operator, and therefore automation of the measurement. Finally, undesired strains of the particles through mechanical or hydrodynamic forces are avoided in comparison to measurements in flow cytometers.

According to a preferred embodiment of the present invention, a morphological parameter of the particle is determined in a first measurement. Morphological parameters or geometrical properties generally include information about the design, shape, or structure of the particle or about the spatial relationships of components of the particle. It may advantageously be determined from the morphological parameters whether the particle should be subjected to further processing steps at all after the measurements. The first measurement preferably includes a transmitted light measurement or an impedance measurement. These measurements may have advantages in regard to rapid and precise detection of the morphological parameter. In addition, it may be determined whether particles are provided individually or connected into aggregates. The latter would be undesirable in cloning experiments, for example. However, an electrical or magnetic measurement may also be performed in the course of the first measurement.

According to a further preferred embodiment of the present invention, a material parameter of the particle which is characteristic for the chemical composition of the particle is determined in a second measurement. Material parameters or properties thus generally include information about the chemical composition of the particle or its components. In biological applications, it may advantageously be determined whether the particle, e.g. a cell, contains specific metabolic products or genetically generated substances. The second measurement preferably includes a fluorescence measurement, which may have advantages in regard to high specificity of the substances detected in the particle. However, an electrical measurement (e.g. impedance measurement) or a magnetic measurement may also be performed in the scope of the second measurement.

It is especially advantageous if the first measurement is performed chronologically before the second measurement. The morphological parameter is measured chronologically before the material parameter. In this embodiment, the measurement conditions of the second measurement may advantageously be tailored to the morphological properties of the observed particle. For example, in the event of a large particle, a relatively low intensity of the fluorescent excitation may be set because of the expected high fluorescence signal.

Alternatively, it is possible according to the present invention that the second measurement is performed chronologically before the first measurement. If the material parameter is measured chronologically before the morphological parameter in this case, advantages in regard to the throughput of the measurements may result.

The method according to the present invention may be performed using different types of particles, particularly synthetic or biological particles. Special advantages result from the careful measurement conditions if the particles comprise biological materials, i.e., for example, biological cells, cell groups, cell components, or biologically relevant macromolecules, each possibly combined with other biological particles or synthetic carrier particles. Synthetic particles may comprise solid particles, liquid particles delimited from the suspension medium, or multiphase particles, which form a separate phase in the channel in relation to the suspension medium.

According to a preferred application of the present invention, manipulation elements, particularly dielectric and/or optical elements in the microsystem, are actuated as a function of the result of the comparison of the measurement results in order to subject the observed particles to a further measurement and/or deflection into a specific region or outlet of the microsystem. Preferably, at least one dielectric cage, at least one dielectric switch, and/or at least one optical manipulator are preferably used as the dielectric or optical elements, which are positioned downstream in relation to the measuring stations. The manipulation elements may, however, also be a porator or fluidic components in general, such as a particle deposition unit.

Special advantages may result in regard to the measurement precision if the at least one further measurement performed as a result of the comparison comprises a measurement on the resting particle, which is, for example, fixed in the liquid using a dielectric field cage, for example.

If, according to a variation of the present invention, the time, the direction, and/or the velocity of the passage of the measured particle at the measuring stations is analyzed from the measured parameters of the particle, the downstream manipulation elements may be activated with greater reliability at the times at which the observed particle comes to these elements with the stream. This tracking of the particle movement is also referred to as “cell tracking” and may also be performed between the measuring stations. The “cell tracking” may thus occur within the entire channel of the microsystem.

It is especially advantageous for the particle throughput that, using the method according to the present invention, multiple particles may flow past the measuring stations one after another, and be measured and individually evaluated and processed further. For this purpose, among other things, the cell velocity and/or the movement velocity of the particles, the particle and/or cell spacing, or the flow state come into consideration as the measured variables.

Further objects of the present invention are a measuring device which is adapted for performing the method according to the present invention, and a fluidic microsystem, which is equipped with or connected to a measuring device of this type.

The measuring device according to the present invention is particularly distinguished by at least two measuring stations for measuring particle parameters which are characteristic for different properties of the particular particle, and an analysis device having a comparator device for comparing the parameters with predefined expected values, using which a signal for further measurements or manipulations on the particle may be generated as a function of the result of the comparison.

The measuring stations may generally be set up for optical or electrical measurements. For example, the first measuring station preferably comprises a transmitted light detector or an impedance detector which is combined with a fluorescent detector as the second measuring station.

If the microsystem according to the present invention contains the measuring device as a system component, advantages in regard to the compactness of the construction may result. Alternatively, the measuring device may be provided as an external device, for example, having a microscope construction.

Advantages for the measuring reliability and effectiveness may result if the microsystem is equipped upstream, before the arrangement of the measuring stations, with focusing electrodes for arranging flowing, suspended particles along a linear row parallel to the flow direction. The row is directed toward the measuring stations, so that the measurements are performed under essentially identical geometrical conditions for all particles.

If, according to a further variation of the present invention, the microsystem is equipped downstream, after the arrangement of the measuring stations, with further measuring stations, for example, at least one dielectric cage, at least one dielectric switch, and/or at least one optical and/or magnetic manipulator, special advantages may result in regard to the direct effect of the evaluation results on the further processing of the particles. In particular, the comparator device may be connected directly to the further measuring stations, the dielectric cage, the dielectric switch, and/or the optical manipulator in order to actuate these using a signal of the comparator device.

In one exemplary embodiment of the present invention, the carrier stream channel branches into at least two outlet lines, one of the two outlet lines being used for removing negatively selected particles, while in contrast the other outlet line is used for guiding positively selected particles further. However, it is also possible to provide more than two outlet lines in order to be able to assign the individual particles to different classes, which subsequently experience different treatments.

In one exemplary embodiment of the present invention, the particles suspended in the carrier stream channel are focused eccentrically, for which an eccentrically positioned focusing device is preferably provided. This is advantageous since the particles, which are suspended in the carrier stream channel and are focused eccentrically by the focusing device, automatically reach a specific outlet line in an exactly defined way if there is no activation of a shunt and/or switch positioned in the region of the branching point.

In this case, the possibility arises that the particles suspended in the carrier stream are focused eccentrically on the outlet line for the negatively selected particles. This results in the particles suspended in the carrier stream automatically reaching the outlet line for the negatively selected particles without activation of the shunt and/or switch in this way, while in contrast the shunt and/or switch must be activated in order to convey the particles into the outlet line for the positively selected particles. This arrangement is therefore especially suitable for assays in which only a few particles are positively selected.

However, there is also the alternative possibility that the particles suspended in the carrier stream are focused eccentrically on the side of the outlet line for the positively selected particles, if, for example, the focusing device is positioned eccentrically on this side. This results in the particles suspended in the carrier stream automatically reaching the outlet line for the positively selected particles without activation of the shunt and/or switch, while in contrast activation of the shunt and/or switch is necessary in order to convey the particles into the outlet line for the negatively selected particles. This arrangement is therefore especially suitable for assays in which a larger percentage of the particles are positively selected.

Furthermore, in a preferred exemplary embodiment of the present invention, the electric cage fulfills two functions, specifically fixing the particles suspended in the carrier stream and, in addition, the function of a shunt and/or switch in order to supply the particles suspended in the carrier stream to one of multiple outlet lines. For this purpose, the field cage is positioned in the region of the branching point of the outlet lines.

The concept of a branching point used in the scope of the present description is to be understood generally and is not restricted to the geometrical intersection of the outlet lines. Rather, it is also possible that the cage and/or the switch is positioned upstream, before the intersection of the outlet lines. For example, the concept of a branching point also includes the “separatrix”. This is the partition line of the laminar stream in the carrier stream channel.

Furthermore, it is to be noted that a focusing device may be positioned in at least one of the outlet lines in order to prevent sinking of the particles in the outlet lines. This is advantageous since the flow velocity in the outlet lines falls from the center of the outlet lines toward the walls, so that the suspended particles may accumulate near the walls if they sink in the outlet lines, which is prevented by the focusing device.

In a further exemplary embodiment, the carrier stream channel is fed from at least two intake lines, each of which supplies a carrier stream having suspended particles.

The two partial streams having the suspended particles may first be separated from one another by a separating wall and/or separately assayed from one another by one measuring station each in the upstream region of the carrier stream channel.

The particles of the individual partial streams may then be combined or removed as a function of the result of this assay of the individual partial streams.

Further details and advantages of the present invention are apparent from the following description of the attached drawing.

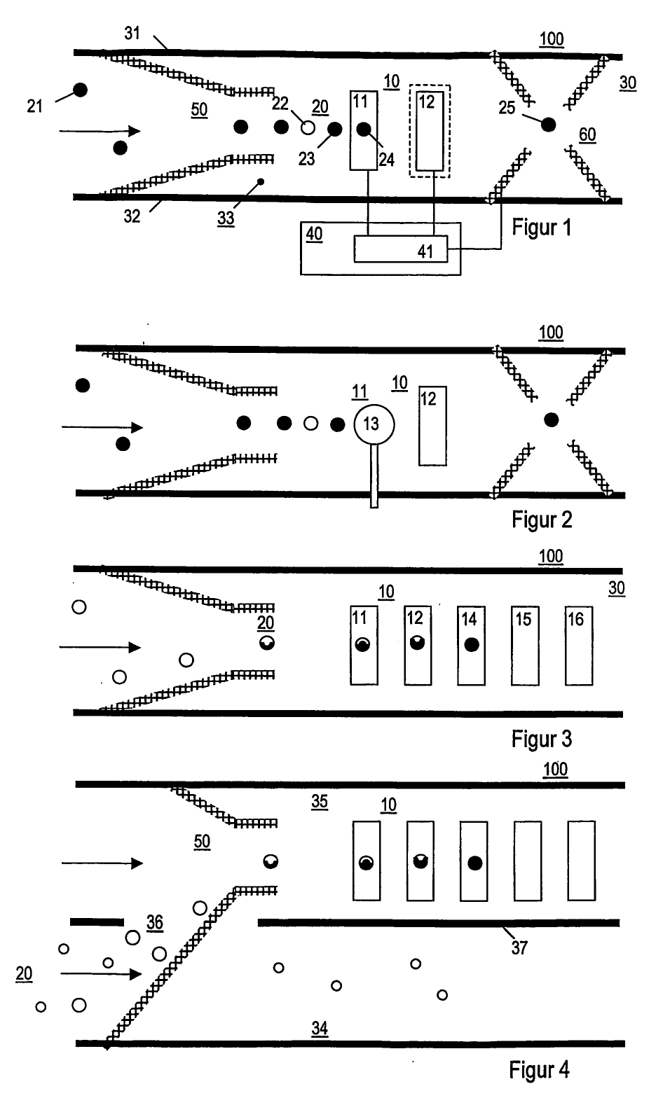

FIGS. 1 through 4: show details of fluidic Microsystems according to the present invention having different embodiments of measuring devices,

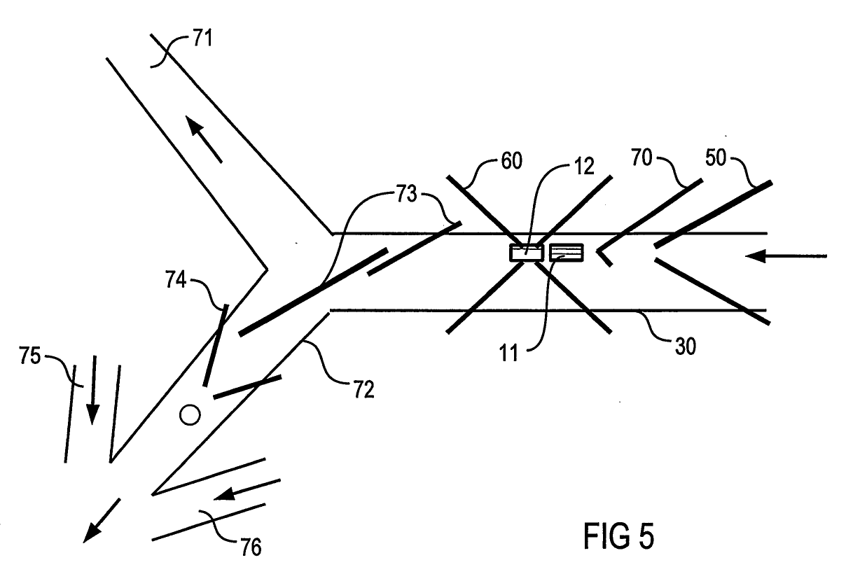

FIGS. 5 to 13: show alternative exemplary embodiments.

FIGS. 1 through 4 illustrate different embodiments of fluidic microsystems according to the present invention in schematic partial views. Fluidic microsystems, particularly for manipulating biological cells, are known per se and will therefore not be described in greater detail here. In the following, the present invention will be explained with reference to the measurement and manipulation of biological cells, without being restricted to this exemplary embodiment.

FIG. 1 shows a channel 30 (or a compartment) of the microsystem 100 in a schematic top view. The channel 30 is delimited by the lateral walls 31, 32, a floor 33, and a ceiling surface (not shown). The distance between the lateral surfaces 31, 32 is preferably in the range from 50 μm to 5 mm, particularly in the range from 100 μm to 1 mm, and especially in the range from 200 to 800 μm (width of the channel), while the distance between the floor 33 and the ceiling surface is preferably approximately 5 μm to 200 μm, e.g., 20 to 100 μm (height of the channel). The microsystem 100 is preferably made of a transparent material, for example, glass or plastic, walls having optical quality (such as microscope cover glasses) preferably being used at least in the region of the measuring stations in the detection direction. A liquid stream flows through the channel 30 in the direction of the arrow. The liquid stream is typically a laminar stream having a flow velocity in the range of, for example, 20 μm/s to 20 mm/s. Cells 20, 21, 22 . . . are suspended in the liquid stream, which are to be detected using the method according to the present invention. The cells move in the flow direction at the same velocity as the liquid.

A measuring device 10 according to the present invention, which generally comprises two schematically illustrated measuring stations 11, 12, is provided in the channel 30. The measuring stations, which are generally set up for optical measurements, are constructed as is known per se for scattered light, transmitted light, phase contrast, or fluorescence measurements. They comprise an illumination device and a detector device (not shown in detail). The illumination device is used, depending on the measuring task, solely for illumination or for excitation of fluorescent light and comprises, for example, a laser light source. Every detector device is set up for detecting the light transmitted, shadowed, scattered, or emitted by a cell and, depending on the measuring task, comprises one or more light-sensitive elements, such as photodiodes or CCD lines or arrays. The detection may be performed directly or after optical enlargement using a microscope from the ceiling or floor surface.

The illumination device may be designed for local fluorescence excitation. This may be connected with the advantages that in case of local excitation, there is no interference with the first optical detection (phase contrast), multiple local excitation spots may be implemented, and the cell strain is reduced. These advantages are not achieved by typical detection technologies.

To reduce interfering scattered light, which may be incident on the detector device for the fluorescence measurements (12) from the illumination device for the transmitted light measurement (11) or as reflected fluorescence excitation light, the microsystem 100 may be equipped on the ceiling or floor surface with a shielding scattered light mask (shown by dashed lines). The mask is positioned opposite to the fluorescence detector device. In a measurement construction having an inverse microscope (detection of the transmitted light/excitation and detection of the fluorescence from the floor surface 33), the mask is located on the top side (ceiling surface) of the microsystem, for example. This embodiment is especially advantageous for improving the signal/noise ratio for weakly fluorescing cells.

The mask comprises a material opaque to light, particularly an absorbent coating, in order to block out the transmitted light supplied from the other side. For example, the mask may comprise a highly reflective metal coating or a strongly absorbent material, such as carbonized platinum. A metal coating may possibly require an appropriately tailored dichroic mirror, so that the reflected fluorescence excitation light does not interfere with the fluorescence emission measurement. A platinum coating may easily be processed electrolytically from “normal” platinum in the channel. It will reflect the transmitted light and absorb the fluorescence (excitation and emission). This variation is especially advantageous since the fluorescence excitation (e.g., 480 nm) may then not influence the fluorescence emission measurement and the transmitted light measurement.

The measuring device 10 is connected to an analysis device 40, only indicated schematically in FIG. 1, which is used to evaluate the detector signals and particularly contains a comparator device 41, whose function will be explained below.

A focusing device 50 is provided upstream, before the measuring stations 11, 12. The funnel-shaped focusing device 50 is used for arranging the cells linearly along a passage region having a width corresponding to the width of the detectors of the measuring device 10. The focusing device 50 comprises, in a way known per se, focusing electrodes in the form of linear electrode strips, each of which is oriented on the ceiling surface and/or on the floor 33 from the channel edge toward the channel center. The ends of the focusing electrodes are spaced apart from one another, so that the passage region is formed. The focusing electrodes are each connected via a connection line (not shown) to a control device (having a high-frequency voltage source).

A dielectric field cage 60 having a group of eight strip-shaped electrodes, in which a cell 25 may be held and measured in a way known per se under the effect of high-frequency fields, is positioned downstream, after the measuring stations 11, 12. The measurement in the field cage 60 comprises, for example, an electrorotation measurement or a high-resolution fluorescence measurement.

Performing the method according to the present invention comprises the following steps. Firstly, the cells 21 flow unordered with the liquid through the channel 30 until they reach the focusing device 50. At this device, a funnel-shaped field barrier is produced by the focusing electrodes, which narrows in the flow direction. In the arrangement thus formed, the cells 20 pass the measuring stations 11, 12 on a joint trajectory.

A transmitted light measurement, for example, in the phase contrast method, is performed as the first measurement at the first measuring station 11. As soon as the cell 24 appears above the first measuring station 11, a first positive signal is generated which represents the instant of the passage. Furthermore, the transmitted light measurement provides an image or, if the detector device is masked, a partial image of the cell 24 which, as the morphological parameter, provides information about the type of the object, the object size or shape, or the object state (for example, living/dead cells), for example. In addition, the velocity of the object may be determined with a suitable mask shape.

A fluorescence measurement, which is offset chronologically and spatially, is performed as the second measurement at the second measuring station 11. As soon as the cell appears above the second measuring station 12, a second positive signal is generated. Furthermore, the fluorescence measurement provides information on whether the cell is charged with a specific marker or contains a specific substance (e.g., expression of genes using GFP), for example. The fluorescence measurement may, like the transmitted light measurement, be performed to produce an image, a detector mask (see above) which is known per se being able to be provided.

Alternatively, a reversed detection sequence may be provided by first measuring the fluorescence and then the phase contrast. This may be advantageous if the fluorescence events are very rare.

The positive signals and the detector signals of the measuring stations are provided to the analysis device 40. The correlation of the positive signals (time difference) allows the determination of the object velocity and therefore the trigger for switching further dielectric and/or optical elements, such as the dielectric field cage 60. The detector signals are compared in the comparator device 41 to specific expected values, which are stored in the analysis device, also to obtain control signals for downstream dielectric and/or optical elements.

According to FIG. 1, for example, unstained (22) and calcein-stained (23) cells are arranged and measured. A high-resolution fluorescence microscope assay (particularly imaging) is to be performed in the field cage 60 if the cells are living and stained (fluorescent). Correspondingly, the detector signals of the measuring stations are compared to specific expected values in regard to the cells (living/dead) and the intensity in the fluorescence detection (threshold value comparison). If both requirements are fulfilled for a specific cell, the field cage 60 is automatically activated in a timely manner so that the cell is captured, and the liquid stream in the channel 30 is stopped for the duration of the high-resolution microscopic assay. For this assay, the illumination device of the second measuring station 12 may advantageously be shifted to the field cage 60. Dead or non-fluorescing cells would be registered, but are not captured in the field cage 60. The throughput is advantageously significantly elevated in this way, which has a special effect in “rare event sorting”, in which rare events are sought in multiple samples (for example, 1:100).

Downstream dielectric switches may be actuated as a function of control signals of the analysis device in order to deflect specific cells into a neighboring channel or decouple them into a cultivation device. The deflection into neighboring channel is performed in reverse to the principle shown in FIG. 4.

According to an altered embodiment of the present invention shown in FIG. 2, the first measuring station 11 comprises an impedance detector 13. The impedance detector 13 is positioned in the flow direction at a distance in the range of, for example, 10 μm to 2 mm from the focusing device 50. The impedance detector comprises, in way known per se, for example, two or four detector electrodes which are positioned on the ceiling surface and/or on the floor 33 of the channel 30 and have AC voltages applied to them for the impedance measurement in the channel 30. Using the impedance detector 13, a measurement signal is obtained from which the size of the cell and possibly the vitality state may be derived, analogously to the optical measurement. Interfering scattered light effects between the measuring stations may advantageously be avoided. The interaction with the second measuring station 12 and the analysis device (not shown) occurs as described above.

FIG. 3 shows an embodiment of the present invention in which further measuring stations 14, 15, . . . are positioned downstream from the first and second measuring stations 11, 12. The measuring stations 14, 15, . . . are set up like the measuring station 15 for a fluorescence measurement and are also connected to the analysis device (not shown). This design allows a first cell parameter (for example, the size) to be measured first at the measuring station 11 and subsequently a second cell parameter (for example, the fluorescence intensity) subsequently to be measured repeatedly at the measuring stations 12 and 14, 15, . . . . A series of fluorescence intensities is determined which is characteristic for the kinetics of a change of the cells as they pass the measuring device 10.

For example, cells 20 flow through the channel 30 suspended in a fluorescent pigment solution and are arranged using the focusing device 50. In the course of the movement, pigment is increasingly enriched in the cells. The degree of enrichment may be detected quantitatively at the measuring stations (e.g., detection of calcium kinetics or a progressive charging with a fluorescing material, e.g., calcein AM). Through correlated analysis of the individual detector signals, the fluorescence may be measured specifically for the individual cells as a function of the time.

FIG. 4 illustrates an application of the present invention in a dual channel system. The microsystem 100 comprises two channels 34, 35, which are connected via a passage opening 36 in a partition wall 37. A measuring device 10 and further measuring stations are located in channel 35 analogously to FIG. 3. Cells 20 suspended in a carrier liquid are flushed into the channel 34. Via a combined dielectric element 50, which combines a deflection function and the above-mentioned funnel function, the cells may be transferred into the second channel 35 and arranged dielectrically there. Generally, there is a different chemical environment or, for example, a fluorescent pigment solution in the channel 35. The pigment enriches in the transferred cells in the course of time. Analogously to FIG. 3, a fluorescence readout and a measurement of the kinetics of the pigment enrichment is performed at predefined measuring locations. The excitation of the cells is performed for this purpose using a planar illumination (objective field of vision). To reduce fading, the coupling of local excitation and detection is advantageous.

The deflection function of the combined dielectric element 50 may be set in such a way that specific cells pass the field barrier in the channel 34 (e.g., small cells, on which only a slight dielectrophoretic force acts in comparison to the hydrodynamic force), while the remaining cells are deflected into the channel 35 (large cells). The cells transferred into the channel 34 may additionally be controlled as a function of the detector signals of the measuring device 10 in such a way that too many cells are prevented from being located simultaneously in the region of the measuring device 10. However, an assay may also be performed in the channel 34, the assay methods described above being able to be applied.

According to the present invention, a dielectric element may be provided, using which the approaching particles, particularly cells on multiple trajectories, are arranged separately and supplied separately to measuring devices which are positioned in or on the microsystem.

The exemplary embodiment illustrated in FIG. 5 largely corresponds to the exemplary embodiment described above and illustrated in FIG. 1, so that to avoid repetitions, reference is made to the above description and in the following only the special features of this exemplary embodiment are described. In addition, the same reference numbers are used in the following for corresponding components as in the description of FIG. 1, in order to make assignment easier.

A special feature of this exemplary embodiment is that a hook-shaped electrode arrangement 70 is positioned in the channel 30 between the focusing device 50 and the field cage 60, upstream from the measuring station 11, which allows particles suspended in the carrier stream to be fixed and parked in front of the measuring station. The construction and the mode of operation of the electrode arrangement 70 is described, for example, in Müller, T. et al.: “Life Cells in Cell Processors” in Bioworld 2, 2002, so that a detailed description of the electrode arrangement 70 may be dispensed with and the content of this publication is to be included in the present description in its entirety.

A further special feature of this exemplary embodiment is that the channel 30 branches downstream, after the field cage 60, into two outlet lines 71, 72, in order to select the particles suspended in the carrier stream as a function of the assay result of the measuring stations 11, 12. The outlet line 71 is used here to receive and remove negatively selected particles, while in contrast, the outlet line 72 is used to receive and guide positively selected particles further.

The distribution of the particles to the two outlet lines 71, 72 is performed for this purpose through a further electrode arrangement 73, which is positioned in the region of the branching point of the two outlet lines 71, 72 and in which an electrical activation drives the positively selected particles into the outlet line 72. The construction and the mode of operation of the electrode arrangement 73 is described, for example, in Müller, T. et al.: “A 3-D microelectrode system for handling and caging single cells and particles” in Biosensors & Bioelectronics 14 (1999) 247-256, so that a more detailed description of the electrode arrangement 73 may be dispensed with and the content of the above-mentioned publication is to be included in its entirety in the present description.

Furthermore, it is to be noted that the focusing device 50, the electrode arrangement 70, the two measuring stations 11, 12, the field cage 60, and the electrode arrangement 73 are positioned eccentrically in the channel 30 on the side of the outlet line 71. This has the result that the particle stream focused eccentrically by the focusing device 50 in the channel 30 automatically reaches the outlet line 71 for negatively selected particles without external action, while in contrast activation of the electrode arrangement 73 is necessary in order to convey the particles into the outlet line 72 for positively selected particles. This eccentric position is therefore especially suitable in investigations in which only a few particles are selected positively, since the electrode arrangement 73 must then only be activated rarely.

Furthermore, it is to be noted that a further focusing device 74 is positioned in the outlet line 72 for the positively selected particles, whose construction and function corresponds to the focusing device 50 in the channel 30. The focusing device 74 has the task of preventing sinking of the particles in the outlet line 72 and holding the particles in the outlet line 72 centrally in the region of greater flow velocities. This is advantageous, since the flow velocity in the outlet line 72 falls from the middle toward the outside, so that the particles may accumulate near the wall if they sink in the outlet line 72, which is prevented by the focusing device 74.

Finally, it is also to be noted that this exemplary embodiment 2 has envelope stream supply lines 75, 76, which discharge downstream, after the focusing device 74, into the outlet line 72 and supply an envelope stream in order to ensure rapid and reliable sample delivery, for example.

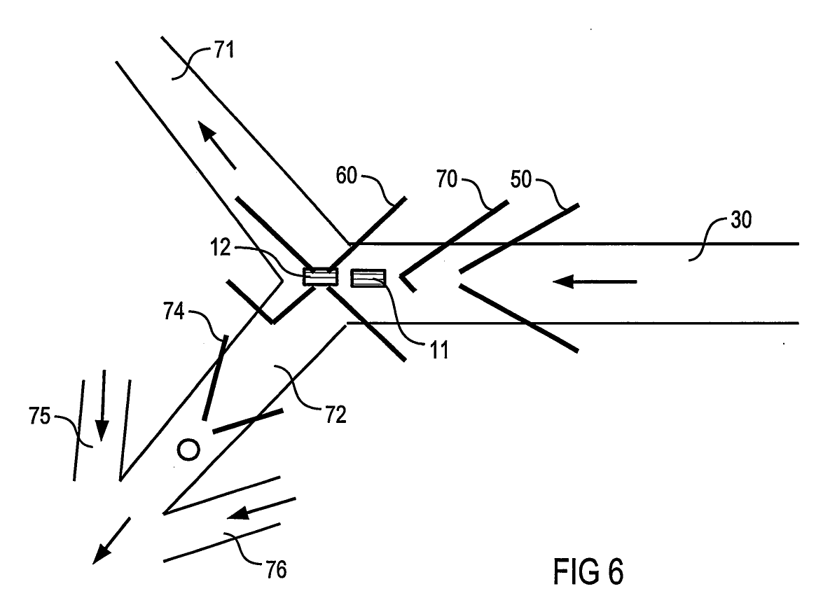

The exemplary embodiment illustrated in FIG. 6 largely corresponds to the exemplary embodiment described above and illustrated in FIG. 5, so that, to avoid repetitions, reference will largely be made to the above description, while only the special features of this exemplary embodiment will be described in the following.

A special feature of this exemplary embodiment is that the field cage 60 is positioned in the branching region of the two outlet lines 71, 72 and fulfills two functions in this case, specifically fixing the particles for the assay by the measuring station 12 and, in addition, distributing the particles to the two outlet lines 71, 72.

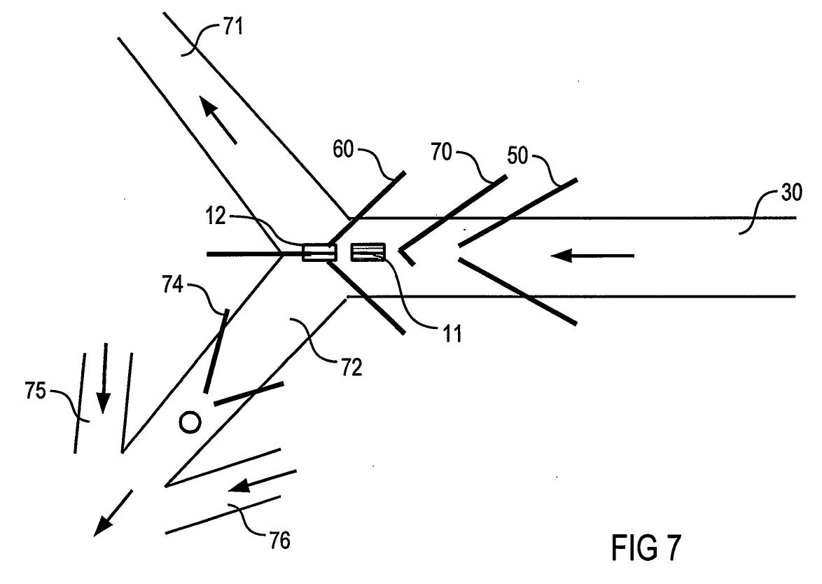

The exemplary embodiment illustrated in FIG. 7 largely corresponds to the exemplary embodiment described above and illustrated in FIG. 6, so that, to avoid repetitions, reference will largely be made to the above description, while only the special features of this exemplary embodiment will be described in the following.

A special feature of this exemplary embodiment is the constructive design of the field cage 60, which comprises six electrodes that are positioned spatially distributed here. The field cage 60 is also bifunctional in this case, however, and allows both fixing of particles in the carrier stream for assay by the measuring station 12 and also distribution of the particles to both outlet lines 71, 72.

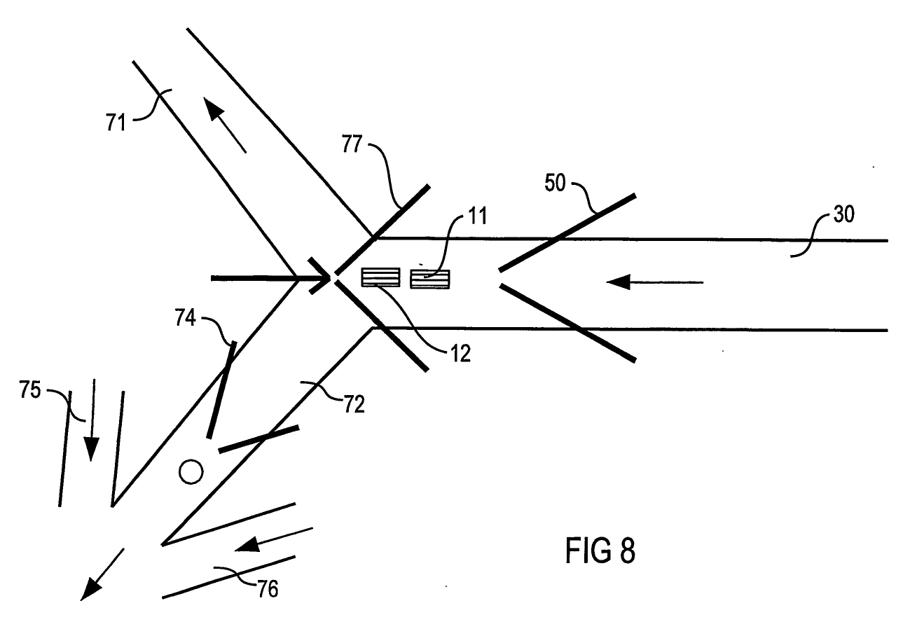

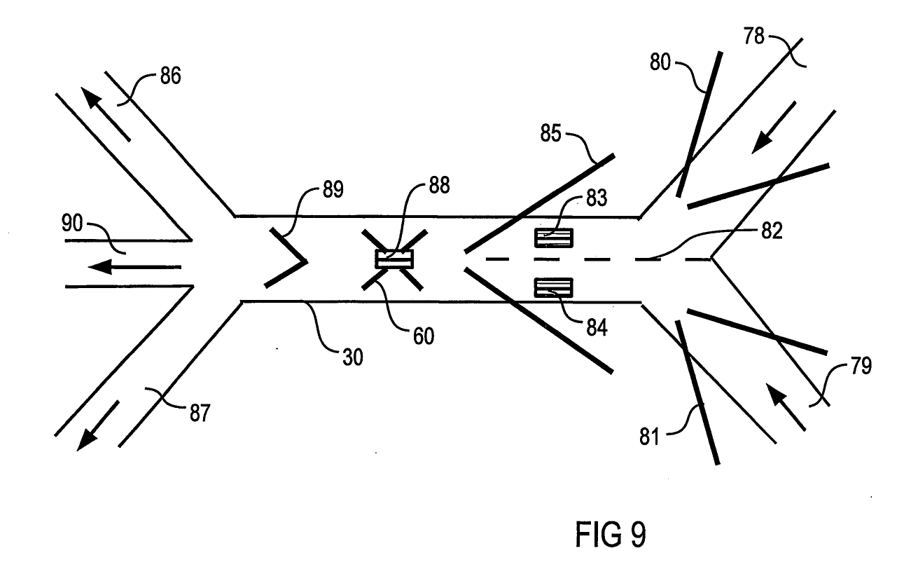

Furthermore, the focusing device 50, the electrode arrangement 70, the field cage 60, and the measuring stations 11, 12 are positioned centrally in the channel 30 in this case, which also applies correspondingly for the following FIGS. 8 and 9.

The exemplary embodiment illustrated in FIG. 8 largely corresponds to the exemplary embodiment described above and illustrated in FIG. 7, so that, to avoid repetitions, reference will largely be made to the above description, while only the special features of this exemplary embodiment will be described in the following.

A special feature of this exemplary embodiment is that a sorting element 77 in the form of an electrode arrangement is positioned in the channel 30 in the branching point of the two outlet lines 71, 72, in order to supply the particles suspended in the particle stream to one of the two outlet lines 71, 72 as a function of the assay by the measuring stations 11, 12. The sorting device is also referred to as an “ultrafast sorter” (UFS) and allows rapid sorting of the suspended particles. The arrow electrodes, which lie one on top of another, are permanently activated in this case, while the deflection into the outlet line 71 or into the outlet line 72 is performed by switching the upper or lower intake electrode pair, respectively, of the sorting device 77. It is to be noted in this case that the lateral spacing of the electrodes is smaller than the vertical spacing.

FIG. 9 shows a further exemplary embodiment in which the channel 30 has two intake lines 78, 79, which discharge into the channel 30 and each supply a carrier stream having suspended particles.

A focusing device 80, 81 is positioned in each of the two intake lines 78, 79, in order to focus the particles contained in the two carrier streams of the intake lines 78, 79.

A partition wall 82 is positioned upstream in the channel 30, in the region of the discharge location of the intake lines 78, 79, which initially separates the carrier streams supplied via the two intake lines 78, 79 in the upstream region of the channel 30. However, the partition wall 82 is merely optional, so that the partition wall 82 may also be dispensed with.

A measuring station 83, 84 is positioned on each side of the partition wall 82 in the channel 30, in order to examine the particles suspended in the two partial streams.

As a function of this assay, the particles are either focused centrally by a focusing device 85 and supplied to the field cage 60 or they flow laterally past the field cage 60 and reach two outlet lines 86, 87 for negatively selected particles.

A further measuring station 88 is located in the channel 30, which allows an assay of the suspended particles in the field cage 60, i.e., in the braked state.

As a function of this further assay, the particles are then supplied by a sorting device 89 either to one of the two outlet lines 86, 87 for negatively selected particles or to a further outlet line 90 for positively selected particles.

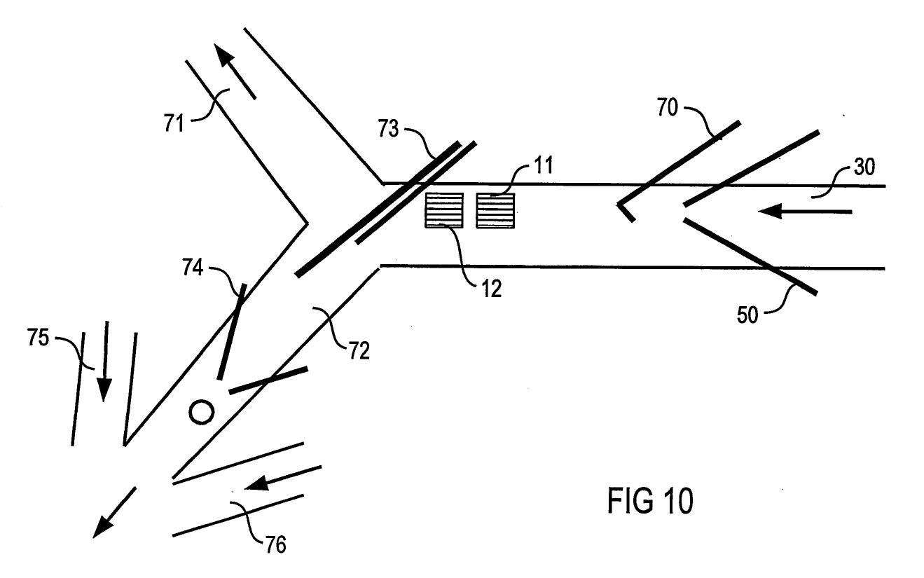

The exemplary embodiment illustrated in FIG. 10 largely corresponds to the exemplary embodiment described above and illustrated in FIG. 5, so that, to avoid repetitions, reference will largely be made to the above description, while only the special features of this exemplary embodiment will be described in the following.

A special feature of this exemplary embodiment is that there is no field cage positioned in the channel 30 in order to fix the particles suspended in the carrier stream.

The assay of the particles suspended in the carrier stream is thus performed in this case during their flow movement.

A further special feature of this exemplary embodiment is the constructive design of the electrode arrangement 73, which is implemented here as a double electrode.

The focusing device 50, the electrode arrangement 70, the two measuring stations 11, 12, and the electrode arrangement 73 are also positioned eccentrically on the side of the outlet line 71 for the negatively selected particles in this case, so that the electrode arrangement 73 must be activated in order to convey the particles suspended in the carrier stream into the outlet line 72 for positively selected particles. This eccentric positioning is therefore especially suitable for assays in which only a small percentage of particles are positively selected.

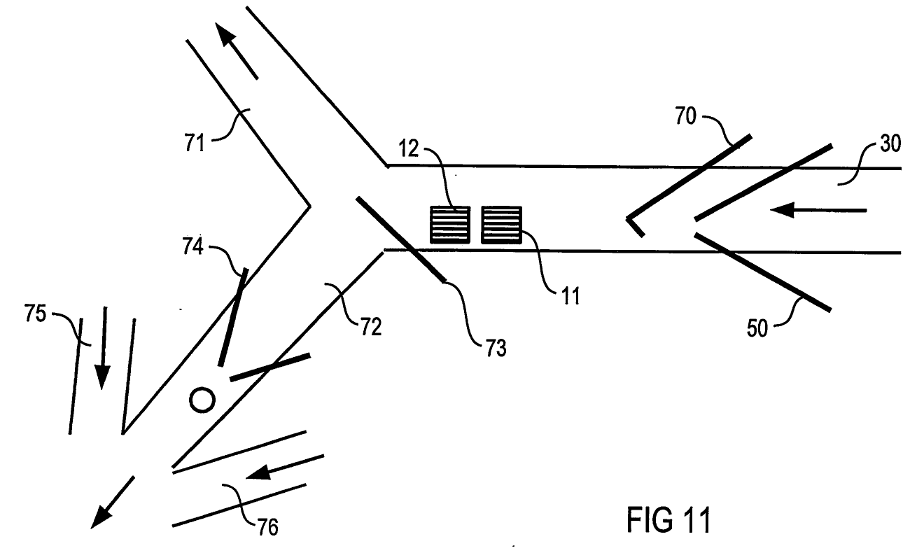

The exemplary embodiment illustrated in FIG. 11 largely corresponds to the exemplary embodiment described above and illustrated in FIG. 10, so that, to avoid repetitions, reference will largely be made to the above description, while only the special features of this exemplary embodiment will be described in the following.

A special feature of this exemplary embodiment is that the focusing device 50, the electrode arrangement 70, the two measuring stations 11, 12, and the electrode arrangement 73 are positioned eccentrically in the channel 30 on the side of the outlet line 72 for positively selected particles. Without activation of the electrode arrangement 73, the particles, which are suspended in the carrier stream and are focused eccentrically by the focusing device 50 in the channel 30, thus automatically reach the outlet line 72 for positively selected particles, while in contrast the electrode arrangement 73 must be activated in order to convey the particles suspended in the carrier stream into the outlet line 71 for negatively selected particles.

This eccentric positioning is therefore especially suitable for those assays in which only a small percentage of the suspended particles are negatively selected.

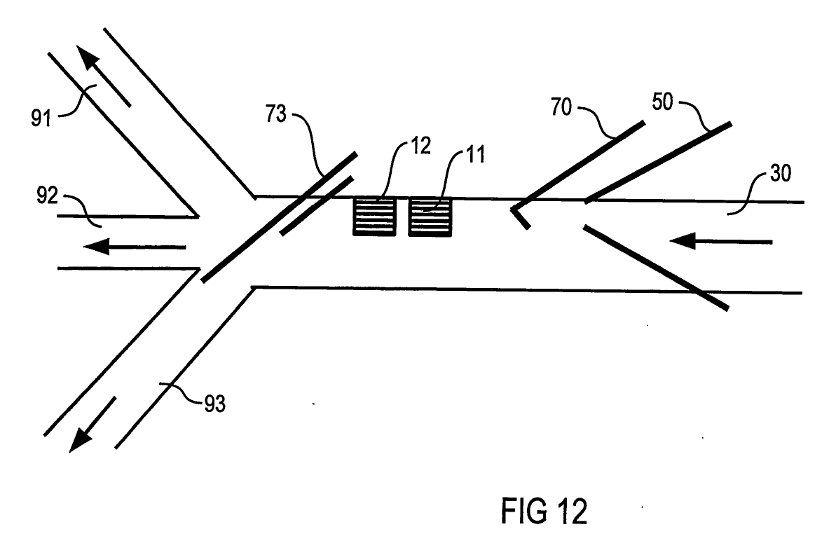

The exemplary embodiment illustrated in FIG. 12 largely corresponds to the exemplary embodiment described above and illustrated in FIG. 10, so that, to avoid repetitions, reference will largely be made to the above description, while only the special features of this exemplary embodiment will be described in the following.

A special feature of this exemplary embodiment is that the channel 30 branches downstream, below the two measuring stations 11, 12, into three outlet lines 91, 92, 93, so that the particles suspended in the carrier stream may be divided into three classes.

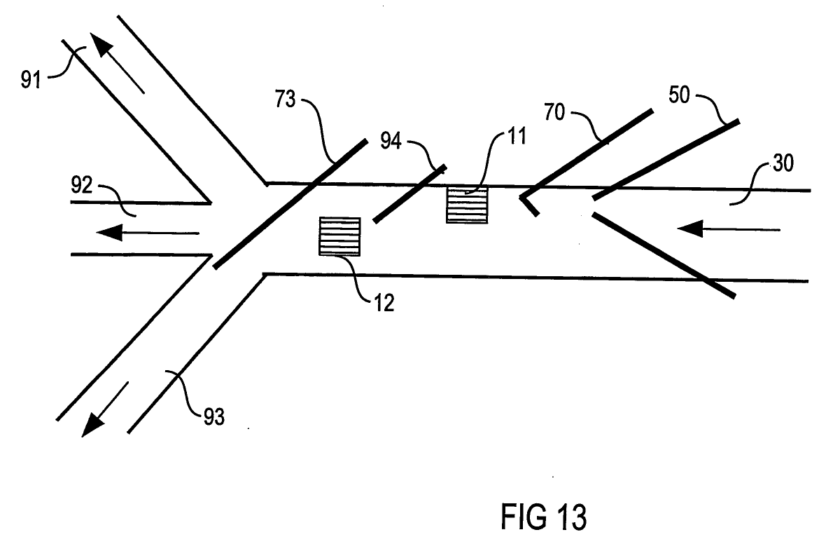

The exemplary embodiment illustrated in FIG. 13 largely corresponds to the exemplary embodiment described above and illustrated in FIG. 12, so that, to avoid repetitions, reference will largely be made to the above description of FIG. 12, while only the special features of this exemplary embodiment will be described in the following.

A special feature of this exemplary embodiment is that the two measuring stations 11, 12 do not lie one after another in the flow direction, but rather are laterally offset to one another in relation to the flow direction, a deflection device 94 being positioned between the two measuring stations 11, 12, which allows lateral deflection of the particles suspended in the carrier stream. Without activation of the deflection device 94, the particles suspended in the carrier stream and focused by the focusing device thus only pass the measuring station 11 and flow laterally past the measuring station 12.

If the deflection device 94 is activated, in contrast, the particles suspended in the carrier stream are deflected laterally to the measuring station 12 after leaving the measuring station 11 and also pass this station. In this case, the deflection device 94 is activated as a function of the result of the assay by the measuring station 11.

The features of the present invention disclosed in the above description, the claims, and the drawing may be of significance both individually and in combination for implementing the present invention in its different embodiments.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A method for measuring properties of particles, which move through a fluidic microsystem suspended in a liquid, comprising:
a) a first measurement of a first parameter of a specific particle at a first measuring station,
b) a second measurement of a second parameter of the particle at an interval in time from the first measurement at a second measuring station, which is spatially separated from the first measuring station, and
c) a joint, correlated evaluation of the first and second parameters,
d) the first and second parameters being characteristic for different properties of the measured particle,
e) the evaluation comprising a comparison and/or a correlation of the first and second parameters with predefined expected values, and
f) a further measurement or manipulation follows on the measured particle as a function of the result of the comparison.

30. The method according to claim 29, wherein a morphologic parameter of the particle is determined as the first or second parameter.

31. The method according to claim 30, wherein the measurement comprises a transmitted light measurement and/or an impedance measurement and/or an electrical measurement and/or a magnetic measurement.

32. The method according to claims 29, wherein a material parameter of the particle, which is characteristic for the chemical or biological composition of the particle, is determined as the first or second parameter.

33. The method according to claim 32, wherein the measurement comprises a fluorescence measurement.

34. The method according to claim 30, wherein the morphological parameter is measured chronologically before the material parameter.

35. The method according to claim 32, wherein the material parameter is measured chronologically before the morphological parameter.

36. The method according to claim 29, wherein solid particles or liquid particles delimited from the suspension medium pass the measuring stations as the synthetic or biological particles.

37. The method according to claim 36, wherein the biological particles comprise biological cells, cell groups, cell components or biologically relevant macromolecules or compositions thereof.

38. The method according to claim 29, wherein the measured particle moves past the measuring stations with the liquid during the first and second measurements.

39. The method according to claim 29, wherein the at least one further measurement performed as a result of the comparison comprises a measurement on the resting particle, which is fixed in the liquid.

40. The method according to claim 29, wherein at least one manipulation element and/or at least one further measuring station in the microsystem is actuated as a function of the result of the comparison of at least two measurements.

41. The method according to claim 40, wherein at least one dielectric cage, at least one dielectric switch, at least one dielectric manipulator and/or at least one optical manipulator and/or one magnetic manipulator are actuated as a function of the result of the comparison.

42. The method according to claim 29, wherein the time, the direction, and/or the velocity of the passage of the measured particle past the measuring stations is analyzed from the measured parameters.

43. The method according to claim 29, wherein multiple particles are measured sequentially and evaluated individually.

44. The method according to claim 29, wherein a time dependence of at least one of the measured parameters is recorded at multiple measuring stations.

45. The method according to claim 29, wherein the particles are transferred from a first channel into a second channel, in which there is a different chemical environment than in the first channel and in which the first and following measurements are performed directly after the transfer from the first channel.

46. A measuring device for measuring properties of particles, which move through a fluidic microsystem suspended in a liquid, having:
a) a first measuring station for a first measurement of a first parameter of a particle,
b) a second measuring station for a second measurement of a second parameter of the particle, which is positioned spatially separated from the first measuring station, and
c) an evaluation device for joint, correlated evaluation of the first and second parameters,
d) the first and second measuring stations being set up for measuring parameters which are characteristic for different properties of the particle,
e) while the analysis device contains a comparator device for comparing the first and second parameters to predefined expected values, and
f) using the comparator device, a signal may be generated for further measurements or manipulations on the particle as a function of the result of the comparison.

47. The measuring device according to claim 46, wherein the first measuring station comprises a transmitted light detector device or an impedance detector.

48. The measuring device according to claim 46, wherein the second measuring station comprises a fluorescence detector device and/or an electrical detector device and/or a magnetic detector device.

49. The measuring device according to claim 48, wherein the fluorescence detector device is shielded to reduce interfering scattered light using a scattered light mask.

50. A fluidic microsystem which is equipped with a measuring device according to claim 46.

51. The fluidic microsystem according to claim 50, wherein the first and second measuring stations are positioned in a joint channel of the fluidic microsystem.

52. The fluidic microsystem according to claim 50, wherein focusing electrodes are provided upstream, before the arrangement of the measuring stations.

53. The fluidic microsystem according to claim 50, which comprises two channels, which are connected via a passage opening in a partition wall, wherein the passage opening is provided upstream, before the arrangement of the measuring stations, and is equipped with a manipulation element for transferring particles from the first into the second channel.

54. The fluidic microsystem according to claim 50, wherein further measuring stations and/or manipulation elements are provided downstream, after the arrangement of the measuring stations.

55. The fluidic microsystem according to claim 54, wherein the comparator device is connected to the measuring stations and/or manipulation elements, so that these may be actuated using the signal of the comparator device.

56. The fluidic microsystem according to claim 55, wherein the measuring stations and/or manipulation elements comprise at least one dielectric cage, at least one dielectric switch, at least one dielectric manipulator, and/or at least one optical manipulator.
